(19) United States
(12) Patent Application Publication
(10) Pub. No.: US 2018/0059819 A1
(43) Pub. Date: Mar. 1, 2018

(54) TOUCH-SENSITIVE OBJECTS

(71) Applicant: Tactual Labs Co., New York, NY (US)

(72) Inventors: Braon Moseley, Round Rock, TX (US); David Clark Wilkinson, Austin, TX (US); Clifton Forlines, South Portland, ME (US); Steven Leonard Sanders, New York, NY (US)

(73) Assignee: Tactual Labs Co., New York, NY (US)

(21) Appl. No.: 15/251,859

(22) Filed: Aug. 30, 2016

Related U.S. Application Data
(60) Provisional application No. 62/379,649, filed on Aug. 25, 2016.

(51) Int. Cl. G06F 3/044; G06F 3/041; G06F 3/046

(52) U.S. Cl. CPC G06F 3/044; G06F 3/0416; G06F 3/016; G06F 2203/04104; G06F 2203/04108; G06F 3/046

(57) ABSTRACT

Disclosed is a touch-sensitive object, comprising an object with a digital skin covering at least a portion thereof. The digital skin has a plurality of embedded row conductors. A plurality of column conductors are positioned in proximity to the row conductors, such that the path of each row conductor crosses the path of each of the column conductor. A plurality of signal emitters are connected to each of the plurality of embedded row conductors and are adapted to simultaneously emit one of a set of source signals. A plurality of signal receivers are connected to separate ones of the plurality of embedded column conductors. Each of the plurality of signal receivers are adapted to receive a frame corresponding to signals present on the column conductor to which it is connected while the frame is acquired. Each of the signal receivers is adapted to receive its frames simultaneously with each other signal receiver. A signal processor is adapted to generate a heat map reflecting electromagnetic disturbance proximate to the digital skin based, at least in part, on the received frames.

This application is a non-provisional of and claims priority to U.S. Provisional Patent Application No. 62/379,649, entitled “Touch-Sensitive Objects,” filed Aug. 25, 2016.

### FIELD

The disclosed apparatus and methods relate in general to the field of user input, and in particular to input surface objects that are sensitive to touch, including, hover, grip and pressure.

### BACKGROUND

The ability, as disclosed herein, to sense hover, contact, grip and pressure information—and to have that information readily available to understand a user's touch, gestures and interactions with a handheld object—introduces myriad possibilities for users interacting with touch-sensitive objects. Because handheld objects come in myriad shapes, it can be difficult to incorporate capacitive touch sensors into handheld objects with a one-size-fits-all approach that enables the object to provide information relative to a user's gestures and other interactions with a handheld device.

These drawbacks are overcome, as disclosed herein, with a novel touch-sensitive object that incorporates a digital skin and/or embeds capacitive touch sensors into the touch-sensitive object or grip of a touch-sensitive object to quickly and accurately sense hover, contact, grip and/or pressure information. Because of the speed and accuracy of the digital skin and capacitive sensors, the novel touch-sensitive object can acquire information concerning not only contact, but it can also be used to determine the shape and position of the capacitive object in the relation to the touch-sensitive object, and thus, is useful in connection with augmented reality (AR) and virtual reality (VR) applications. For example, using the novel touch-sensitive object, a model of the user's hand and/or forearm, in addition to the touch-sensitive object itself, may be created and displayed in a VR setting, enabling a user to operate a touch-sensitive object by virtual “sight,” essentially seeing what they are doing within the virtual world. Many other possibilities for the touch-sensitive object will be appreciated by a person of ordinary skill in the art in view of the disclosures herein.

### BRIEF DESCRIPTION OF THE DRAWINGS

The foregoing and other objects, features, and advantages of the disclosure will be apparent from the following more particular description of embodiments as illustrated in the accompanying drawings, in which reference characters refer to the same parts throughout the various views. The drawings are not necessarily to scale, emphasis instead being placed upon illustrating principles of the disclosed embodiments.

FIG. 1 shows a high level block diagram illustrating an embodiment of a low-latency touch sensor device.

FIG. 2 shows a functional block diagram of an illustrative frequency division modulated touch sensitive device.

FIG. 3A shows an exemplary row and column configuration for a touch-sensitive object.

FIG. 3B shows another exemplary row and column configuration for a touch-sensitive object.

FIGS. 4A-D are schematic cross-sectional diagrams (not to scale) of various illustrative embodiments of a touch-sensitive object according to the present invention.

FIG. 5 shows an exemplary object with a user's hands grasping the exemplary object, and a computer generated heat map superimposed onto a computer generated recreation of the object to correspond to the positioning and proximity of the user's hands in relation to the exemplary object.

FIG. 6 shows an exemplary embodiment of a tennis racket with a user's hand holding the tennis racket, and a computer generated heat map superimposed onto a computer generated recreation of the tennis racket to correspond to the positioning and proximity of the user's hand in relation to the tennis racket.

FIG. 7 shows an example of a heat map of the user's fingers, hands, and wrists while holding a touch-sensitive object and the object's sensory range.

FIG. 8 shows a heat map of a user's fingers, hands, and wrists, and visual context relative to the ping pong paddle when it is in use.

FIG. 9 shows a heat map of the user's fingers, hands, wrists and forearm, and visual context relative to the ball as it is being thrown.

### DETAILED DESCRIPTION

This application relates to user interfaces such as the fast multi-touch sensors and other interfaces disclosed in U.S. patent application Ser. No. 15/056,805, filed Feb. 29, 2016 entitled “Alterable Ground Plane for Touch Surfaces” and U.S. patent application Ser. No. 15/224,266, filed Jul. 29, 2016 entitled “Hover-Sensitive Touchpad.” The entire disclosures of these applications are incorporated herein by reference.

In various embodiments, including those illustrated herein, the present disclosure is directed to touch-sensitive objects and methods for designing, manufacturing and their operation. Although example compositions or geometries are disclosed for the purpose of illustrating the invention, other compositions and geometries will be apparent to a person of skill in the art, in view of this disclosure, without departing from the scope and spirit of the disclosure herein.

Throughout this disclosure, the terms “hover”, “touch”, “touches,” “contact,” “contacts,” “pressure,” “pressures” or other descriptors may be used to describe events or periods of time in which a user's finger, a stylus, an object or a body part is detected by the sensor. In some embodiments, and as generally denoted by the word “contact”, these detections occur when the user is in physical contact with a sensor, or a device in which it is embodied. In other embodiments, and as generally referred to by the term “hover”, the sensor may be tuned to allow the detection of “touches” that are hovering at a distance above the touch surface or otherwise separated from the touch sensitive device. As used herein, “touch surface” may or may not have actual features, and could be a generally feature-sparse surface. The use of language within this description that implies reliance upon sensed physical contact should not be taken to mean that the techniques described apply only to those embodiments; indeed, generally, what is described herein applies equally to “contact” and “hover”, each of which being a “touch” as that term is used herein. More generally, as used herein, the term “touch” refers to an act that can be detected by the types of sensors disclosed herein, thus, as used herein the term “hover” is one type of “touch” in the sense that “touch” is intended herein. “Pressure” refers to a force with which a user presses their fingers or hand (or another object such as a stylus) against the surface of a touch-sensitive object. The amount of “pressure” is may be a measure of “contact”, i.e., touch area, or as described, may be a measure otherwise related to the pressure of a touch. Touch refers to the states of “hover”, “contact” “pressure” or “grip”, whereas a lack of “touch” is generally identified by changes in signals being outside the threshold for accurate measurement by the sensor. Other types of sensors may be utilized in connection with the embodiments disclosed herein, including a camera, a proximity sensor, an optical sensor, a turn-rate sensor, a gyroscope, a magnetometer, a thermal sensor, a pressure sensor, a capacitive sensor, a power-management integrated circuit reading, a motion sensor, and the like.

As used herein, including within the claims, ordinal terms such as first and second are not intended, in and of themselves, to imply sequence, time or uniqueness, but rather, are used to distinguish one construct, e.g., on claimed construct, from another. In some uses where the context dictates, these terms may imply that the first and second are unique. For example, where an event occurs at a first time, and another event occurs at a second time, there is no intended implication that the first time occurs before the second time. However, where the further limitation that the second time is after the first time is presented in the claim, the context would require reading the first time and the second time to be unique times. Similarly, where the context so dictates or permits, ordinal terms are intended to be broadly construed so that the two identified claim constructs can be of the same characteristic or of different characteristic. Thus, for example, a first and a second frequency, absent further limitation, could be the same frequency—e.g., the first frequency being 10 Mhz and the second frequency being 10 Mhz; or could be different frequencies—e.g., the first frequency being 10 Mhz and the second frequency being 11 Mhz. Context may dictate otherwise, for example, where a first and a second frequency are further limited to being orthogonal to each other, in which case, they could not be the same frequency.

The presently disclosed systems and methods provide for designing, manufacturing and using capacitive touch sensors, and including capacitive touch sensors that employ a multiplexing scheme based on orthogonal signaling such as but not limited to frequency-division multiplexing (FDM), code-division multiplexing (CDM), or a hybrid modulation technique that combines both FDM and CDM methods. References to frequency herein could also refer to other orthogonal signal bases. Capacitive FDM, CDM, or FDM/CDM hybrid touch sensors may be used in connection with the presently disclosed sensors. In such sensors, touches may be sensed when a signal from a row is coupled (increased) or decoupled (decreased) to a column and the result received on that column.

This disclosure will first describe the general operation of certain fast multi-touch sensors which may be used in connection with the touch sensitive objects described herein, or to implement the present systems and methods for design, manufacturing and operation thereof. Details of the presently disclosed systems and methods related to objects sensitive to hover, contact and pressure are described below under the heading “Touch-sensitive objects.”

As used herein, the phrase “touch event” and the word “touch” when used as a noun include a near touch and a near touch event, or any other gesture that can be identified using a sensor. In accordance with an embodiment, touch events may be detected, processed and supplied to downstream computational processes with very low latency, e.g., on the order of ten milliseconds or less, or on the order of less than one millisecond.

In an embodiment, the disclosed fast multi-touch sensor utilizes a projected capacitive method that has been enhanced for high update rate and low latency measurements of touch events. The technique can use parallel hardware and higher frequency waveforms to gain the above advantages. Also disclosed are methods to make sensitive and robust measurements, which methods may be used on transparent display surfaces and which may permit economical manufacturing of products which employ the technique. In this regard, a “capacitive object” as used herein could be a finger, other part of the human body, a stylus, or any object to which the sensor is sensitive. The sensors and methods disclosed herein need not rely on capacitance. With respect to, e.g., an optical sensor, an embodiment utilizes photon tunneling and leaking to sense a touch event, and a “capacitive object” as used herein includes any object, such as a stylus or finger, that that is compatible with such sensing. Similarly, “touch locations” and “touch sensitive device” as used herein do not require actual touching contact between a capacitive object and the disclosed sensor.

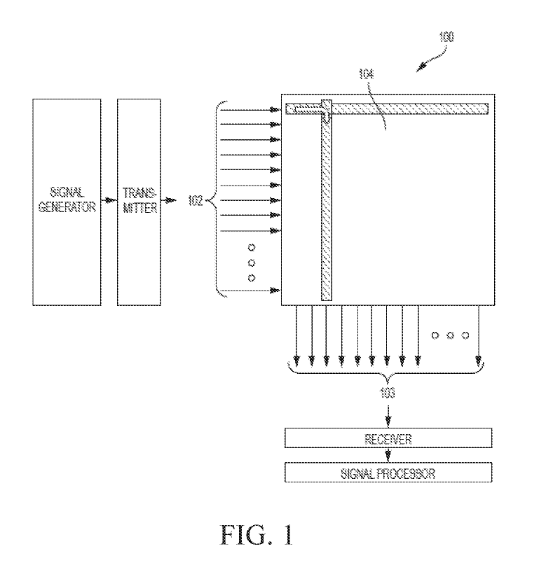

FIG. 1 illustrates certain principles of a fast multi-touch sensor 100 in accordance with an embodiment. At reference no. 102, differing signals are simultaneously transmitted into a plurality of rows. The differing signals are “orthogonal”, i.e., separable and distinguishable from each other. At reference no. 103, a receiver is attached to each column. The receiver is designed to receive any of the transmitted signals, or an arbitrary combination of them, with or without other signals and/or noise, and to individually determine at least one measure, e.g., a quantity, for each of the simultaneously transmitted signals present on each of the columns. The touch surface 104 of the sensor comprises a series of rows and columns (not all shown), along which the orthogonal signals can propagate. In an embodiment, the rows and columns may be designed so that, when they are not subject to a touch event, a lower or negligible amount of signal is coupled between them, whereas, when they are subject to a touch event, a higher or non-negligible amount of signal is coupled between them. In an embodiment, the opposite could hold—having the lesser amount of signal represent a touch event, and the greater amount of signal represent a lack of touch. Because the touch sensor ultimately detects touch due to a change in the coupling, it is not of specific importance, except for reasons that may otherwise be apparent to a particular embodiment, whether the touch-related coupling causes an increase in amount of row signal present on the column or a decrease in the amount of row signal present on the column. As discussed above, the touch, or touch event does not require a physical touching, provided that the touch is an event that affects the level of coupled signal.

With continued reference to FIG. 1, in an embodiment, generally, the capacitive result of a touch event in the proximity of both a row and column may cause a non-negligible change in the amount of signal present on the row to be coupled to the column. More generally, touch events cause, and thus correspond to, the received signals on the columns. Because the signals on the rows are orthogonal, multiple row signals can be coupled to a column and distinguished by the receiver. Likewise, the signals on each row can be coupled to multiple columns. For each column coupled to a given row (and regardless of whether the coupling causes an increase or decrease in the row signal to be present on the column), the signals found on the column contain information that will indicate which rows are being touched in proximity with that column. The quantity of each signal received is generally related to the amount of coupling between the column and the row carrying the corresponding signal, and thus, may indicate a distance of the touching object to the surface, an area of the surface covered by the touch and/or the pressure of the touch.

When a touch occurs in proximity to a given row and column, the level of the signal that is present on the row is changed in the corresponding column (the coupling may cause an increase or decrease of the row signal on the column). (As discussed above, the term touch or touched does not require actual physical contact, but rather, relative proximity.) Indeed, in various implementations of a touch device, physical contact with the rows and/or columns is unlikely as there may be a protective barrier between the rows and/or columns and the finger or other object of touch. Moreover, generally, the rows and columns themselves are not in touch with each other, but rather, placed in a proximity that allows an amount of signal to be coupled there-between, and that amount changes (increases or decreases) with touch. Generally, the row-column coupling results not from actual contact between them, nor by actual contact from the finger or other object of touch, but rather, by the capacitive effect of bringing the finger (or other object) into proximity—which proximity resulting in capacitive effect is referred to herein as touch.

The nature of the rows and columns is arbitrary and the particular orientation is irrelevant. Indeed, the terms row and column are not intended to refer to a square grid, but rather to conductors upon which signal is transmitted (rows) and conductors onto which signal may be coupled (columns). (The notion that signals are transmitted on rows and received on columns itself is arbitrary, and signals could as easily be transmitted on conductors arbitrarily designated columns and received on conductors arbitrarily named rows, or both could arbitrarily be named something else.) Further, it is not necessary that the rows and columns be in a grid. As discussed herein, other shapes and orientations are possible. Provided that a touch event will affect the intersection of a “row” and a “column”, and cause some change in coupling between them. For example, in two dimensions, the “rows” could be in concentric circles and the “columns” could be spokes radiating out from the center. And neither the “rows” nor the “columns” need to follow any geometric or spatial pattern. In a three dimensional example, the rows could be helical around an imaginary cylinder, and the columns may be coaxial with such cylinder. Moreover, it is not necessary for there to be only two types of signal propagation channels: instead of rows and columns, in an embodiment, channels “A”, “B” and “C” may be provided, and signals transmitted on “A” could be received on “B” and “C”, or, in an embodiment, signals transmitted on “A” and “B” could be received on “C”. It is also possible that the signal propagation channels can alternate function, at different times supporting transmitters and receivers. It is also contemplated that the signal propagation channels can simultaneously support transmitters and receivers—provided that the signals transmitted are separable from the signals received. Many alternative embodiments are possible and will be apparent to a person of skill in the art in view of this disclosure.

As noted above, in an embodiment the touch surface 104 comprises of a series of rows and columns, along which signals can propagate. As discussed above, the rows and columns are designed so that, when they are not being touched, one amount of signal is coupled between them, and when they are being touched, another amount of signal is coupled between them. The change in signal coupled between them may be generally proportional or inversely proportional (although not necessarily linearly proportional) to the touch such that touch is not so much a yes-no question, but rather, more of a gradation, permitting distinction between touches, e.g., more touch (i.e., closer or firmer) and less touch (i.e., farther or softer)—and even no touch. When a touch occurs in proximity to a row/column crossing, the signal that is present on the column is changed (positively or negatively). The quantity of the signal that is coupled onto a column may be related to the proximity, pressure or area of touch.

A receiver is attached to each column. The receiver is designed to receive the signals present on each column, including any of the orthogonal signals, or an arbitrary combination of the orthogonal signals, and any noise or other signals present. Generally, the receiver is designed to receive a frame of signals present on the columns, and to quantify each of the row signals present in that frame. In an embodiment, the frame is captured by an ADC on each column, and the time-domain data captured by the ADC is converted into frequency domain data reflective with “buckets” for each different frequency that is transmitted on a row. In an embodiment, the receiver (or a signal processor associated with the receiver data) may determine a measure associated with the quantity of each of the orthogonal transmitted signals present on that column during the time the frame of signals was captured. In this manner, in addition to identifying the rows in touch with each column, the receiver can provide additional (e.g., qualitative) information concerning the touch. In general, touch events may correspond (or inversely correspond) to the received signals on the columns. In an embodiment, for each column, the different signals received thereon indicate which of the corresponding rows are being touched in proximity with that column. In an embodiment, the amount of coupling between the corresponding row and column may indicate e.g., the area of the surface covered by the touch, the pressure of the touch, etc. In an embodiment, a change in coupling over time between the corresponding row and column indicates a change in touch at the intersection of the two.

### Sinusoid Illustration

In an embodiment, the orthogonal signals being transmitted onto the rows may be unmodulated sinusoids, each having a different frequency, the frequencies being chosen so that they can be distinguished from each other in the receiver. In an embodiment, frequencies are selected to provide sufficient spacing between them such that they can be more easily distinguished from each other in the receiver. In an embodiment, frequencies are selected such that no simple harmonic relationships exist between the selected frequencies. The lack of simple harmonic relationships may mitigate non-linear artifacts that can cause one signal to mimic another.

Generally, a “comb” of frequencies, where the spacing between adjacent frequencies is constant, and the highest frequency is less than twice the lowest, will meet these criteria if the spacing between frequencies, Δf, is at least the reciprocal of the measurement period τ. For example, if it is desired to measure a combination of signals (from a column, for example) to determine which row signals are present once per millisecond (τ), then the frequency spacing (Δf) must be greater than one kilohertz (i.e., Δf>1/τ). According to this calculation, in an example case with ten rows, one could use the following frequencies:

| | |
|---|---|
| Row 1: | 5.000 MHz |
| Row 2: | 5.001 MHz |
| Row 3: | 5.002 MHz |
| Row 4: | 5.003 MHz |
| Row 5: | 5.004 MHz |
| Row 6: | 5.005 MHz |
| Row 7: | 5.006 MHz |
| Row 8: | 5.007 MHz |
| Row 9: | 5.008 MHz |
| Row 10: | 5.009 MHz |

It will be apparent to one of skill in the art in view of this disclosure that frequency spacing may be substantially greater than this minimum to permit robust design. As an example, a 20 cm by 20 cm touch surface with 0.5 cm row/column spacing may require forty rows and forty columns and necessitate sinusoids at forty different frequencies. While a once per millisecond analysis rate would require only 1 KHz spacing, an arbitrarily larger spacing is utilized for a more robust implementation. In an embodiment, the arbitrarily larger spacing is subject to the constraint that the maximum frequency should not be more than twice the lowest (i.e., fₘₐₓ<2(fₘᵢₙ)). Thus, in this example, a frequency spacing of 100 kHz with the lowest frequency set at 5 MHz may be used, yielding a frequency list of 5.0 MHz, 5.1 MHz, 5.2 MHz, etc. up to 8.9 MHz.

In an embodiment, each of the sinusoids on the list may be generated by a signal generator and transmitted on a separate row by a signal emitter or transmitter. To identify the rows and columns that proximate to a touch, a receiver receives a frame of signals present on the columns and a signal processor analyzes the signal to determine which, if any, frequencies on the list appear. In an embodiment, the identification can be supported with a frequency analysis technique (e.g., Fourier transform), or by using a filter bank. In an embodiment, the receiver receives a frame of column signals, which frame is processed through an FFT, and thus, a measure is determined for each frequency. In an embodiment, the FFT provides an in-phase and quadrature measure for each frequency, for each frame.

In an embodiment, from each column's signal, the receiver/signal processor can determine a value (and potentially an in-phase and quadrature value) for each frequency from the list of frequencies found in the signal on that column. In an embodiment, where the value of a frequency is greater or lower than some threshold, or changes from the prior value, the signal processor identifies there being a touch event between the column and the row corresponding to that frequency. In an embodiment, signal strength information, which may correspond to various physical phenomena including the distance of the touch from the row/column intersection, the size of the touch object, the pressure with which the object is pressing down, the fraction of row/column intersection that is being touched, etc. may be used as an aid to localize the area of the touch event. In an embodiment, the determined values are not self-determinative of touch, but rather are further processed along with other values to determine touch events.

Once values for each of the orthogonal frequencies have been determined for at least a plurality of frequencies (each corresponding to a row) or for at least a plurality of columns, a two-dimensional map can be created, with the value being used as, or proportional/inversely proportional to, a value of the map at that row/column intersection. In an embodiment, values are determined at multiple row/column intersections on a touch surface to produce a map for the touch surface or region. In an embodiment, values are determined for every row/column intersection on a touch surface, or in a region of a touch surface, to produce a map for the touch surface or region. In an embodiment, the signals' values are calculated for each frequency on each column. Once signal values are calculated a two-dimensional or three-dimensional map may be created. In an embodiment, the signal value is the value of the map at that row/column intersection. In an embodiment, the signal value is processed to reduce noise before being used as the value of the map at that row/column intersection. In an embodiment, another value proportional, inversely proportional or otherwise related to the signal value (either after being processed to reduce noise) is employed as the value of the map at that row/column intersection. In an embodiment, due to physical differences in the touch surface at different frequencies, the signal values are normalized for a given touch or calibrated. Similarly, in an embodiment, due to physical differences across the touch surface or between the intersections, the signal values need to be normalized for a given touch or calibrated.

In an embodiment, the map data may be thresholded to better identify, determine or isolate touch events. In an embodiment, the map data is used to infer information about the shape, orientation, etc. of the object touching the surface.

In an embodiment, such analysis and any touch processing described herein may be performed on a touch sensor's discrete touch controller. In another embodiment, such analysis and touch processing could be performed on other computer system components such as but not limited to one or more ASIC, MCU, FPGA, CPU, GPU, SoC, DSP or dedicated circuit. The term “hardware processor” as used herein means any of the above devices or any other device which performs computational functions.

Returning to the discussion of the signals being transmitted on the rows, a sinusoid is not the only orthogonal signal that can be used in the configuration described above. Indeed, as discussed above, any set of signals that can be distinguished from each other will work. Nonetheless, sinusoids may have some advantageous properties that may permit simpler engineering and more cost efficient manufacture of devices which use this technique. For example, sinusoids have a very narrow frequency profile (by definition), and need not extend down to low frequencies, near DC. Moreover, sinusoids can be relatively unaffected by 1/f noise, which noise could affect broader signals that extend to lower frequencies.

In an embodiment, sinusoids may be detected by a filter bank. In an embodiment, sinusoids may be detected by frequency analysis techniques (e.g., Fourier transform/fast Fourier transform). Frequency analysis techniques may be implemented in a relatively efficient manner and may tend to have good dynamic range characteristics, allowing them to detect and distinguish between a large number of simultaneous sinusoids. In broad signal processing terms, the receiver's decoding of multiple sinusoids may be thought of as a form of frequency-division multiplexing. In an embodiment, other modulation techniques such as time-division and code-division multiplexing could also be used. Time division multiplexing has good dynamic range characteristics, but typically requires that a finite time be expended transmitting into (or analyzing received signals from) the touch surface. Code division multiplexing has the same simultaneous nature as frequency-division multiplexing, but may encounter dynamic range problems and may not distinguish as easily between multiple simultaneous signals.

### Modulated Sinusoid Illustration

In an embodiment, a modulated sinusoid may be used in lieu of, in combination with and/or as an enhancement of, the sinusoid embodiment described above. The use of unmodulated sinusoids may cause radiofrequency interference to other devices near the touch surface, and thus, a device employing them might encounter problems passing regulatory testing (e.g., FCC, CE). In addition, the use of unmodulated sinusoids may be susceptible to interference from other sinusoids in the environment, whether from deliberate transmitters or from other interfering devices (perhaps even another identical touch surface). In an embodiment, such interference may cause false or degraded touch measurements in the described device.

In an embodiment, to avoid interference, the sinusoids may be modulated or “stirred” prior to being transmitted by the transmitter in a manner that the signals can be demodulated (“unstirred”) once they reach the receiver. In an embodiment, an invertible transformation (or nearly invertible transformation) may be used to modulate the signals such that the transformation can be compensated for and the signals substantially restored once they reach the receiver. As will also be apparent to one of skill in the art, signals emitted or received using a modulation technique in a touch device as described herein will be less correlated with other things, and thus, act more like mere noise, rather than appearing to be similar to, and/or being subject to interference from, other signals present in the environment.

In an embodiment, a modulation technique utilized will cause the transmitted data to appear fairly random or, at least, unusual in the environment of the device operation. Two modulation schemes are discussed below: Frequency Modulation and Direct Sequence Spread Spectrum Modulation.

### Frequency Modulation

Frequency modulation of the entire set of sinusoids keeps them from appearing at the same frequencies by “smearing them out.” Because regulatory testing is generally concerned with fixed frequencies, transmitted sinusoids that are frequency modulated will appear at lower amplitudes, and thus be less likely to be a concern. Because the receiver will “un-smear” any sinusoid input to it, in an equal and opposite fashion, the deliberately modulated, transmitted sinusoids can be demodulated and will thereafter appear substantially as they did prior to modulation. Any fixed frequency sinusoids that enter (e.g., interfere) from the environment, however, will be “smeared” by the “unsmearing” operation, and thus, will have a reduced or an eliminated effect on the intended signal. Accordingly, interference that might otherwise be caused to the sensor is lessened by employing frequency modulation, e.g., to a comb of frequencies that, in an embodiment, are used in the touch sensor.

In an embodiment, the entire set of sinusoids may be frequency modulated by generating them all from a single reference frequency that is, itself, modulated. For example, a set of sinusoids with 100 kHz spacing can be generated by multiplying the same 100 kHz reference frequency by different integers. In an embodiment this technique can be accomplished using phase-locked loops. To generate the first 5.0 MHz sinusoid, one could multiply the reference by 50, to generate the 5.1 MHz sinusoid, one could multiply the reference by 51, and so forth. The receiver can use the same modulated reference to perform the detection and demodulation functions.

### Direct Sequence Spread Spectrum Modulation

In an embodiment, the sinusoids may be modulated by periodically inverting them on a pseudo-random (or even truly random) schedule known to both the transmitter and receiver. Thus, in an embodiment, before each sinusoid is transmitted to its corresponding row, it is passed through a selectable inverter circuit, the output of which is the input signal multiplied by +1 or −1 depending on the state of an “invert selection” input. In an embodiment, all of these “invert selection” inputs are driven from the same signal, so that the sinusoids for each row are all multiplied by either +1 or −1 at the same time. In an embodiment, the signal that drives the “invert selection” input may be a pseudorandom function that is independent of any signals or functions that might be present in the environment. The pseudorandom inversion of the sinusoids spreads them out in frequency, causing them to appear like random noise so that they interfere negligibly with any devices with which they might come in contact.

On the receiver side, the signals from the columns may be passed through selectable inverter circuits that are driven by the same pseudorandom signal as the ones on the rows. The result is that, even though the transmitted signals have been spread in frequency, they are despread before the receiver because they have been ben multiplied by either +1 or −1 twice, leaving them in, or returning them to, their unmodified state. Applying direct sequence spread spectrum modulation may spread out any interfering signals present on the columns so that they act only as noise and do not mimic any of the set of intentional sinusoids.

In an embodiment, selectable inverters can be created from a small number of simple components and/or can be implemented in transistors in a VLSI process.

Because many modulation techniques are independent of each other, in an embodiment, multiple modulation techniques could be employed at the same time, e.g., frequency modulation and direct sequence spread spectrum modulation of the sinusoid set. Although potentially more complicated to implement, such multiple modulated implementation may achieve better interference resistance.

Because it would be extremely rare to encounter a particular pseudo random modulation in the environment, it is likely that the multi-touch sensors described herein would not require a truly random modulation schedule. One exception may be where more than one touch surface with the same implementation is being touched by the same person. In such a case, it may be possible for the surfaces to interfere with each other, even if they use very complicated pseudo random schedules. Thus, in an embodiment, care is taken to design pseudo random schedules that are unlikely to conflict. In an embodiment, some true randomness may be introduced into the modulation schedule. In an embodiment, randomness is introduced by seeding the pseudo random generator from a truly random source and ensuring that it has a sufficiently long output duration (before it repeats). Such an embodiment makes it highly unlikely that two touch surfaces will ever be using the same portion of the sequence at the same time. In an embodiment, randomness is introduced by exclusive or'ing (XOR) the pseudo random sequence with a truly random sequence. The XOR function combines the entropy of its inputs, so that the entropy of its output is never less than either input.

### A Low-Cost Implementation Illustration

Touch surfaces using the previously described techniques may have a relatively high cost associated with generating and detecting sinusoids compared to other methods. Below are discussed methods of generating and detecting sinusoids that may be more cost-effective and/or be more suitable for mass production.

### Sinusoid Detection

In an embodiment, sinusoids may be detected in a receiver using a complete radio receiver with a Fourier Transform detection scheme. Such detection may require digitizing a high-speed RF waveform and performing digital signal processing thereupon. Separate digitization and signal processing may be implemented for every column of the surface; this permits the signal processor to discover which of the row signals are in touch with that column. In the above-noted example, having a touch surface with forty rows and forty columns, would require forty copies of this signal chain. Today, digitization and digital signal processing are relatively expensive operations, in terms of hardware, cost, and power. It would be useful to utilize a more cost-effective method of detecting sinusoids, especially one that could be easily replicated and requires very little power.

In an embodiment, sinusoids may be detected using a filter bank. A filter bank comprises an array of bandpass filters that can take an input signal and break it up into the frequency components associated with each filter. The Discrete Fourier Transform (DFT, of which the FFT is an efficient implementation) is a form of a filter bank with evenly-spaced bandpass filters that may be used for frequency analysis. DFTs may be implemented digitally, but the digitization step may be expensive. It is possible to implement a filter bank out of individual filters, such as passive LC (inductor and capacitor) or RC active filters. Inductors are difficult to implement well on VLSI processes, and discrete inductors are large and expensive, so it may not be cost effective to use inductors in the filter bank.

At lower frequencies (about 10 MHz and below), it is possible to build banks of RC active filters on VLSI. Such active filters may perform well, but may also take up a lot of die space and require more power than is desirable.

At higher frequencies, it is possible to build filter banks with surface acoustic wave (SAW) filter techniques. These allow nearly arbitrary FIR filter geometries. SAW filter techniques require piezoelectric materials which are more expensive than straight CMOS VLSI. Moreover, SAW filter techniques may not allow enough simultaneous taps to integrate sufficiently many filters into a single package, thereby raising the manufacturing cost.

In an embodiment, sinusoids may be detected using an analog filter bank implemented with switched capacitor techniques on standard CMOS VLSI processes that employs an FFT-like “butterfly” topology. The die area required for such an implementation is typically a function of the square of the number of channels, meaning that a 64-channel filter bank using the same technology would require only 1/256th of the die area of the 1024-channel version. In an embodiment, the complete receive system for the low-latency touch sensor is implemented on a plurality of VLSI dies, including an appropriate set of filter banks and the appropriate amplifiers, switches, energy detectors, etc. In an embodiment, the complete receive system for the low-latency touch sensor is implemented on a single VLSI die, including an appropriate set of filter banks and the appropriate amplifiers, switches, energy detectors, etc. In an embodiment, the complete receive system for the low-latency touch sensor is implemented on a single VLSI die containing n instances of an n-channel filter bank, and leaving room for the appropriate amplifiers, switches, energy detectors, etc.

### Sinusoid Generation

Generating the transmit signals (e.g., sinusoids) in a low-latency touch sensor is generally less complex than detection, principally because each row requires the generation of a single signal while the column receivers have to detect and distinguish between many signals. In an embodiment, sinusoids can be generated with a series of phase-locked loops (PLLs), each of which multiply a common reference frequency by a different multiple.

In an embodiment, the low-latency touch sensor design does not require that the transmitted sinusoids are of very high quality, but rather, accommodates transmitted sinusoids that have more phase noise, frequency variation (over time, temperature, etc.), harmonic distortion and other imperfections than may usually be allowable or desirable in radio circuits. In an embodiment, the large number of frequencies may be generated by digital means and then employ a relatively coarse digital-to-analog conversion process. As discussed above, in an embodiment, the generated row frequencies should have no simple harmonic relationships with each other, any non-linearities in the described generation process should not cause one signal in the set to “alias” or mimic another.

In an embodiment, a frequency comb may be generated by having a train of narrow pulses filtered by a filter bank, each filter in the bank outputting the signals for transmission on a row. The frequency “comb” is produced by a filter bank that may be identical to a filter bank that can be used by the receiver. As an example, in an embodiment, a 10 nanosecond pulse repeated at a rate of 100 kHz is passed into the filter bank that is designed to separate a comb of frequency components starting at 5 MHz, and separated by 100 kHz. The pulse train as defined would have frequency components from 100 kHz through the tens of MHz, and thus, would have a signal for every row in the transmitter. Thus, if the pulse train were passed through an identical filter bank to the one described above to detect sinusoids in the received column signals, then the filter bank outputs will each contain a single sinusoid that can be transmitted onto a row.

### Integrated Circuit Illustration

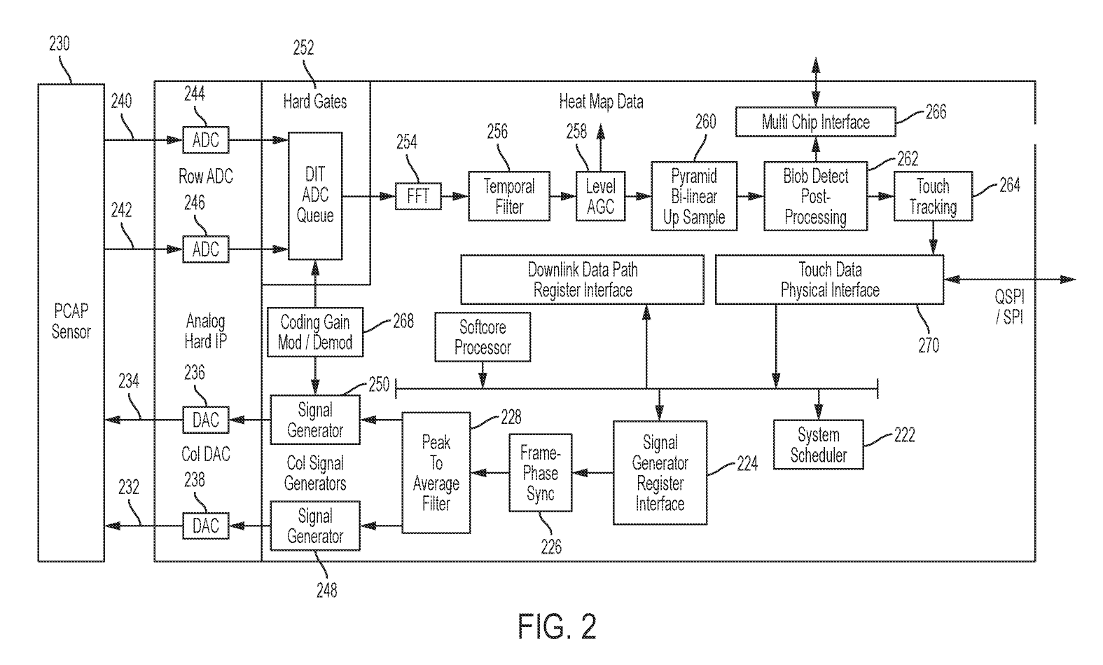

FIG. 2 provides a functional block diagram of an illustrative frequency division modulated touchpad detector. A sensor 230 according to the disclosure is shown; transmitted signals are transmitted to the rows 232, 234 of the touchpad sensor 230 via digital-to-analog converters (DAC) 236, 238 and time domain received signals are sampled from the columns 240, 242 by analog-to-digital converters (ADC) 244, 246. The transmitted signals are time domain signals generated by signal generators 248, 250 which are operatively connected to the DAC 236, 238. A Signal Generator Register Interface block 224 operatively connected to the System Scheduler 222, is responsible for initiating transmission of the time domain signals based on a schedule. Signal Generator Register Interface block 224 communicates with Frame-Phase Sync block 226, which causes Peak to Average Filter block 228 to feed Signal Generator blocks 248, 250 with data necessary to cause the signal generation.

Changes in the received signals are reflective of touch at the touchpad sensor 230, noise and/or other influences. The time domain received signals are queued in hard gates 252, before they are converted into the frequency domain by FFT block 254. A Coding Gain Modulator/Demodulator block 268 provides bidirectional communications between the Signal Generator blocks 248, 250 and hard gates 252. A temporal filter block 256 and level automatic gain control (AGC) block 258 are applied to the FFT block 254 output. The AGC block 258 output is used to prove heat map data and is fed to UpSample block 260. UpSample block 260 interpolates the heat map to produce a larger map in an effort to improve accuracy of Blob Detection block 262. In an embodiment, up sampling can be performed using a bi-linear interpolation. Blob Detection block 262 performs post-processing to differentiate targets of interest. Blob Detection block 262 output is sent to Touch Tracking block 264 to track targets of interest as they appear in consecutive or proximal frames. Blob Detection block 262 output components can also be sent to a multi-chip interface 266 for multi-chip implementations. From the Touch Tracking block 264, results are sent to the Touch Data Physical Interface block 270 for short distance communication via QSPI/SPI.

In an embodiment, there is one DAC per channel. In an embodiment, each DAC has a signal emitter that emits a signal induced by the signal generator. In an embodiment, the signal emitter is driven by analog. In an embodiment, the signal emitter can be a common emitter. In an embodiment, signals are emitted by a signal generator, scheduled by the system scheduler, providing a list of digital values to the DAC. Each time the list of digital values is restarted, the emitted signal has the same initial phase.

In an embodiment, the frequency division modulated touch detector (absent the touchpad sensor) is implemented in a single integrated circuit. In an embodiment, the integrated circuit would have a plurality of ADC inputs and a plurality of DAC outputs. In an embodiment, the integrated circuit would have 36 ADC inputs and 64 orthogonal DAC outputs. In an embodiment, the integrated circuit is designed to cascade with one or more identical integrated circuits, providing additional signal space, such as 128, 192, 256 or more simultaneous orthogonal DAC outputs. In an embodiment, the ADC inputs are capable of determining a value for each of the DAC outputs within the signal space of the orthogonal DAC outputs, and thus, can determine values for DAC outputs from cascaded ICs as well as DAC outputs on the IC where the ADC resides.

### Touch-Sensitive Objects

Use of physical objects in virtual reality or augmented reality (hereinafter, “VR/AR,” even though the two terms can be mutually exclusive) settings is complicated by the fact that a user may not have any view, or a full view, of the object when it is within the VR/AR setting. In some contexts, the use of a physical object, e.g., a football being carried by a player, can obscure full view of the object. Moreover, information about the user interface with a physical object may be important to understand the context in which such an object is being used, or misused. In a sporting context, questions about how a golf club or tennis racquet is being gripped, or whether a football is in the possession of a player at a given moment in time, may be difficult or impossible to ascertain absent information about the user interface, e.g., the grip. In other contexts, user interface information concerning, e.g., how and where a steering wheel is being gripped, or a how a flight stick is being held, may be useful for software attempting to determine a response to a given input. The same can be said about controllers used for playing computer games, operating aircraft or using machinery.

The principles disclosed herein can be used to transform physical objects—e.g., controllers, gaming objects, sports balls (e.g., football, basketball, baseball, soccer ball, etc.), clubs, bats, rackets (e.g., tennis rackets, ping pong paddles, etc.), and instruments (e.g., flute, clarinet, saxophone, etc.)—into touch-sensitive objects that may dynamically report on hover, contact, grip and/or pressure. Such touch-sensitive objects may be provided with touch-sensitive surfaces (e.g., skins) or embedded touch-sensitive layers, and which may be used for both traditional applications, and support numerous new applications enabled by the touch information that can be made available from the touch-sensitive objects.

In an embodiment, the touch-sensitive object can take any shape. Some examples include a touch-sensitive object in the shape of: a cylinder or being generally cylindrical (e.g., aircraft flight stick, control area of a flute, tennis racquet grip, golf-club grip, ping pong paddle grip), a tapering cylinder (e.g., baseball bat, control area of saxophone), a prolate spheroid (e.g., a football), spherical (e.g., basketball, soccer ball), toroidal (e.g., a steering wheel, a hula hoop), disc shaped (e.g., a Frisbee™), or have an arbitrary shape (e.g., game controller or remote control). In an embodiment, in addition to its traditional use, a touch-sensitive object can distinguish contact, hover, grip, gesture, and/or pressure, thus, for example, enabling determination of the position of a user's fingers, hands, wrists and potentially forearms with respect to the touch-sensitive object when being used. In an embodiment, the data acquired from the touch-sensitive object may be used to reconstruct the position and orientation of the user's fingers, hands, wrists, forearms, and potentially, the touch-sensitive object in a VR/AR setting. Such reconstruction may allow a user to “see” his or her fingers, hands, wrists and possibly forearms relative to the touch object in VR/AR settings, improving the experience of use of touch-sensitive objects in such settings.

In an embodiment, the touch-sensitive object may be fully or partially wrapped in a “digital skin” that can sense touch, hover, gesture, grip, pressure and/or proximity, and/or can have output that may be used to provide feedback to users. In an embodiment, there is a protective layer outside the “digital skin”. In an embodiment, the touch-sensitive object, e.g., a football, basketball or sports grip (e.g., club or racquet), may have a “digital skin” inside its own external surface, where the “digital skin” can in any event sense touch, hover, gesture, grip, pressure and/or proximity with the touch-sensitive object, and can output information that may be used as a basis to provide feedback to users. In an embodiment, the touch-sensitive object has sensors built in, or embedded within the object itself. In an embodiment, the touch-sensitive object has at least one embedded sensor and is fully or partially wrapped in a digital skin. In an embodiment, a medium-density fireboard (MDF) or plastic object without a screen has an embedded sensor. In an embodiment, the object is associated with a grip that can sense touch, hover, gesture, grip, pressure and/or proximity, and when used in conjunction with post-processing software, can provide feedback to users regarding the use of the touch-sensitive object. In an embodiment, the grip may have embedded sensors. In an embodiment, a touch-sensitive object may have multiple different sensors that can sense a variety of touch, hover, gesture, grip, pressure and/or proximity.

In an embodiment, a VR/AR environment is provided with the ability to map a digital interface of 2-D and 3-D buttons, sliders, screens, and other visual input controls onto an otherwise featureless or feature-sparse touch-sensitive object, or onto a less feature rich touch-sensitive object. In an embodiment, the mapped digital interface can change to flexibly adapt to the user's application or task.

In an embodiment, the touch-sensitive object can sense contact, hover, grip, gesture and/or pressure across its entire surface, or a select area of its surface (e.g., only in the grip). In an embodiment, the touch-sensitive object can provide data pertaining to a user's contact, hover, grip, gesture and/or pressure. In an embodiment, such data can be used to determine finger and/or hand position, and potentially wrist and/or forearm positioning during use. In an embodiment, the touch-sensitive object can enable digital game or sports simulation to retain real-time, real-life play information that provides tailored digital coaching advice that may improve a user's physical play. In an embodiment, the touch-sensitive object can enable a user to, for example, play a digital game with real-life sporting equipment or objects while their finger, hand, wrist and forearm position is mirrored across both physical and VR/AR worlds. In an embodiment, additional sensors (e.g., accelerometer, gyrometer, etc.) can be incorporated into the touch-sensitive objects. In an embodiment, using the output from the touch-sensitive objects (e.g., a touch sensitive ball) real-time data can be provided during sporting events to be used in play-by-play analysis (e.g., allowing the audience to see how the football was thrown or the baseball was pitched, or whether a receiver had sufficient grip to qualify as control of a football).

In an embodiment, a plurality of row conductors are each associated with respective ones of a plurality of signal emitters. In an embodiment, a plurality of column conductors are each associated with respective ones of a plurality of signal receivers, each adapted to receive a frame, or to receive multiple frames in succession from a single column conductor. (At times herein the plurality of receivers is referred to in the singular, as a receiver—but such receiver is adapted to receive a frame or successive frames from each of the plurality of columns.) In an embodiment, the plurality of row and plurality of column conductors (as coupled to the transmitters and receivers) form a touch sensor. In an embodiment, the row and column conductors are embedded in a digital skin surrounding at least a portion of an object, and causing at least a portion to be touch sensitive. In an embodiment, the row and column conductors are embedded within the touch-sensitive object, causing at least a portion to be touch sensitive. In an embodiment, the rows conductors are embedded in a digital skin surrounding at least a portion of an object, and the columns are embedded within the object or a portion thereof, or vice versa. In an embodiment, the rows conductors are embedded in a grip forming part of the object, and the columns are embedded in the object or a portion thereof, or vice versa. In an embodiment, the row and column conductors are embedded in a grip forming part of the object, and providing touch sensitivity in the grip. In an embodiment, a signal processor is used to determine an amount, and/or changes in the amount, of the frequency orthogonal source signal present on each of the various column conductors. In an embodiment, the plurality of row and column conductors are designed so that, when they are subject to touch, there is a change in the amount of signal coupled between the rows and columns proximate to the touch.

U.S. patent application Ser. No. 15/200,642 filed Jul. 1, 2016, entitled “Touch Sensitive Keyboard” and U.S. patent application Ser. No. 15/221,391 filed Jul. 27, 2016 entitled “Touch Sensitive Keyboard”, the entire disclosures of which are incorporated herein by reference, disclose systems related to keyboards sensitive to hover, contact and pressure. In an embodiment, the touch-sensitive object disclosed herein has a second touch sensor. In an embodiment, the second touch sensor is formed from a key base having at least one transmit antenna and at least one receive antenna proximate to the key base. In an embodiment, a signal emitter is associated with each of the at least one transmit antenna and one signal receiver is operatively coupled with at least one of the at least one receive antenna. In an embodiment, transmit and receive antennae are spaced apart such that no portion of the transmit antenna touches any portion of the receive antenna. In an embodiment, a receiver is coupled to the at least one receive antenna and is adapted to capture a frame of signals present on the coupled receive antenna. In an embodiment, a signal processor is adapted to determine a measurement from each frame, the measurement corresponding to an amount of the source signals present on the receive antenna during a time the corresponding frame was received. In an embodiment, the signal processor is adapted to reflect one of a range of touch states, including a range of hover states, a range of contact states and at least one fully depressed state.

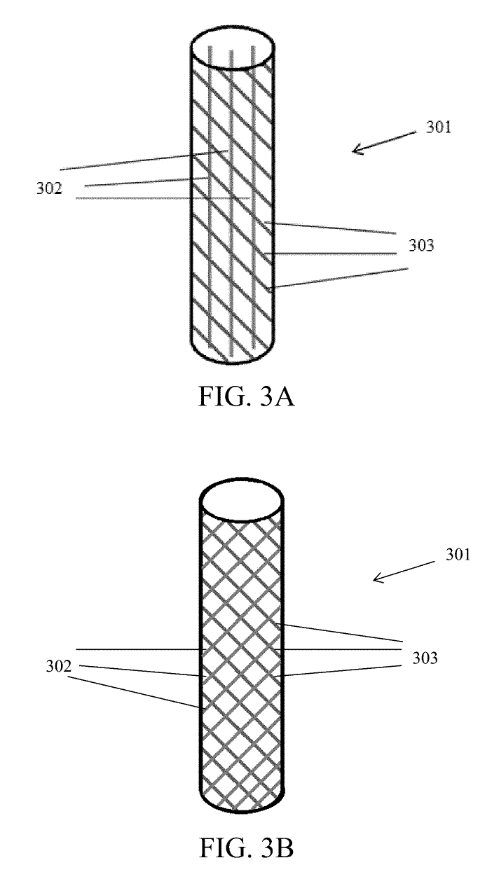

Turning to FIG. 3A, in an illustrative embodiment, a generally cylindrical touch-sensitive object 301 has row conductors 303 oriented in a helix and column conductors 302 arranged such that they are longitudinally oriented with respect to the object and spaced equidistant from each-other (e.g., 120 degrees around from one-another). While the illustration shows three column conductors, more or fewer may be used. In an embodiment, two column conductors are placed at opposing sides (180 degrees) of the generally cylindrical touch-sensitive object 301. In an embodiment, four column conductors are placed at 3 o'clock, 6 o'clock, 9 o'clock and 12 o'clock with respect to the generally cylindrical touch-sensitive object 301. In an embodiment, column conductors are placed around the generally cylindrical touch-sensitive object 301 such that they are spaced by between 2 mm and 5 mm apart from one-another. In an embodiment, column conductors are placed around the generally cylindrical touch-sensitive object 301 such that they are spaced by about 5 mm from one-another. In an embodiment, the column conductors are placed sufficiently near the perimeter of the generally cylindrical touch-sensitive object 301 to allow substantial interaction with the signals on the row conductors. In an embodiment, the helically oriented row conductors may be helically oriented such that they encircle up to 360 degrees around the touch-sensitive object 301. In an embodiment, the row conductors are spaced by between 2 mm and 5 mm from one another. In an embodiment, each helically wound row crosses the path of each longitudinally oriented column conductor no more than once. Where the helically oriented row conductors encircle more than 360 degrees around the touch-sensitive object 301, thus the helically wound rows may cross the path of a longitudinally oriented column conductor more than once—crossing the path of a longitudinally oriented column conductor more than once may make it more difficult to distinguish the location of touch from a frame of data sampled from the column conductor.

Turning to FIG. 3B, in an illustrative embodiment, a touch-sensitive object 301 has row conductors 303 arranged such that they are oriented in a helix and the column conductors 302 are arranged such that they are oriented in a counter-helix (i.e., a helix winding in the opposite direction). In an embodiment, column conductors are spaced by between 2 mm and 5 mm apart from one-another. In an embodiment, column conductors are spaced by about 5 mm from one-another. In an embodiment, row conductors are spaced by between 2 mm and 5 mm apart from one-another. In an embodiment, row conductors are spaced by about 5 mm from one-another. In an embodiment, the column conductors and row conductors are placed sufficiently near the perimeter of the generally cylindrical touch-sensitive object 301 to allow substantial interaction with the signals on the row conductors, and measurable changes in that interaction during a touch event. In an embodiment, the helically oriented row and column conductors may be helically oriented such that they encircle up to 180 degrees around the touch-sensitive object 301. In an embodiment, each helically wound row crosses the path of each helically wound column conductor no more than once. It will be appreciated by a person of skill in the art, in light of this disclosure, that the row conductors and column conductors can be arranged in a variety of positions, whereby there are numerous crossings between the row and column conductors, and their depth and relative position with respect to the touch-sensitive object is suitable to enable them to detect touch.

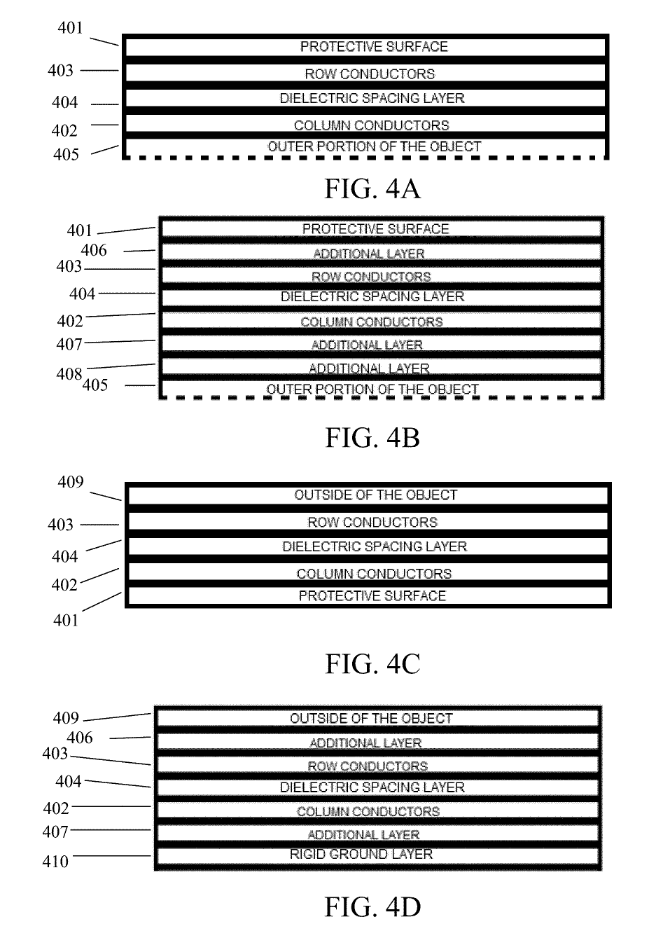

FIG. 4A shows an illustrative cross-section of an outer portion of a touch sensitive object according to one embodiment of the invention disclosed herein. At least a portion of the outside or outer portion of the object 405 is surrounded by a digital skin made up of column conductors 402, a dielectric spacing layer 404, row conductors 403. The digital skin may be protected by an optional protective surface 401. The column conductors 402 are spaced from row conductors 403 by the dielectric spacing layer 404. In an embodiment, the column conductors 402 and row conductors 403 may be affixed to the dielectric spacing layer 404. Although the row conductors 403 are shown further from the outer portion of the object 405 than the dielectric spacing layer 404, and the column conductors 402 are shown closer to the outer portion of the object 405 than the dielectric spacing layer 404 in FIGS. 4A-4D, this is arbitrary and for illustrative purposes only, and the rows and columns may be interchanged without departing from the spirit and scope of the disclosure or invention.

In an embodiment, the protective surface 401 is dielectric. In an embodiment, the protective surface 401 is locally mechanically deformable, for example, by the pressure of a finger or stylus. As used herein locally mechanically deformable (or sometimes just mechanically deformable) refers to a property of a material that it will change shape locally in response to localized pressure such as that exerted by a finger or stylus. Examples of such locally mechanically deformable materials would include rubber, non-rigid plastics or foam or even soft glass constructions such as Willow® Glass which is available from Corning Incorporated of Corning, N.Y. Where protective surface 401 is locally mechanically deformable, increasing pressure associated with a touch from a touch object (e.g., a finger or stylus) may permit the touch object to come into closer proximity with the row conductors 403 or the column conductors 402. The response of the touch-sensitive object is generally higher where the proximity of the touch object is closer to the row conductors 403 or the column conductors 402. It will be apparent to a person of skill in the art in view of this disclosure, that using pressure as a means to bring the touch object into closer proximity with the row and column conductors 402, 403 may increase sensitivity of the measurements that can be made from the touch-sensitive object.

In an embodiment, the dielectric spacing layer 404 is locally mechanically deformable. Where the dielectric spacing layer 404 is locally mechanically deformable, increasing pressure associated with a touch from a touch object (e.g., a finger or stylus) may permit the row conductors 403 to come into closer proximity with the column conductors 402. It will be apparent to a person of skill in the art in view of this disclosure, that using pressure as a means to bring the row and column conductors 402, 403 into closer proximity with each other may increase sensitivity of the measurements that can be made from the touch-sensitive object.

In an embodiment, an outer portion of the object 405 is locally mechanically deformable. In an embodiment, the outer portion of the object 405 is dielectric. In an embodiment, a ground plane or other conductive material (not shown) is embedded within the object 405, or is placed beneath the locally mechanically deformable outer portion of the object 405. Where the outer portion of the object 405 is locally mechanically deformable, increasing pressure associated with a touch from a touch object (e.g., a finger or stylus) may permit the row conductors 403 and the column conductors 402 to deflect together with one-another. In an embodiment, deflection of the row conductors 403 and the column conductors 402 can cause a change in the signal response to touch. It will be apparent to a person of skill in the art in view of this disclosure, that using pressure as a means to bring the row and column conductors 402, 403 into closer proximity with a ground plane may increase sensitivity of the measurements that can be made from the touch-sensitive object.

In an embodiment, the digital skin is integrated into the object.

FIG. 4B shows an illustrative cross-section of an outer portion of a touch sensitive object according to another embodiment of the invention disclosed herein. In addition to what is shown in FIG. 4A, FIG. 4B comprises optional additional layers 406, 407, 408. Each of the optional additional layers 406, 407, 408, to the extent employed, may be locally mechanically deformable. In an embodiment, both the protective surface 401 and the outermost additional layer 406 are both mechanically deformable. In an embodiment, the deformability (i.e., the pressure required to deform) of the dielectric spacing layer 404 and the additional layers 406, 407, 408 may be the same, or may differ from one-another. It will be apparent to a person of skill in the art in view of this disclosure, that varying the deformability among the dielectric spacing layer 404, and the additional layers 406, 407, 408 may increase sensitivity of the measurements that can be made from the touch-sensitive object.

FIG. 4C shows an illustrative cross-section of an outer portion of a touch sensitive object according to yet another embodiment of the invention disclosed herein. In an embodiment, the object itself is hollow and outside the digital skin (e.g., football or basketball), rather than beneath the digital skin, or the digital skin is part of or integrated into the object (e.g., bowling ball). In an embodiment, the outside of the object 409 may be adjacent to a digital skin which includes row and column conductors 402, 403 on opposing sides of a dielectric spacing layer 404. In an embodiment, an optional protective surface 401 may protect the inner-more conductors (402 as shown) from damage. The nature of some objects (e.g., football or basketball) is that they are themselves locally mechanically deformable, while generally speaking, others are not (e.g., bowling ball). FIG. 4D shows additional optional locally mechanically deformable layers 406, 407, 408 that may be employed when the object being made touch-sensitive by a digital skin itself is locally mechanically deformable.

In addition to what is shown in FIG. 4C, FIG. 4D comprises optional additional layers 406, 407, and optional rigid ground layer 410. Either or both of the additional layers 406, 407, if employed, may be locally mechanically deformable. It will be apparent to a person of skill in the art in view of this disclosure, that varying the deformability among the layer 404, the additional layer 406, and the additional layer 407 if optional rigid ground layer 410 is used, may increase sensitivity of the measurements that can be made from the touch-sensitive object.

In an embodiment, the deformable digital skin has an inside surface proximate to the object, an outside surface distal from the object, a top portion between the plurality of row conductors and the outside surface, a middle portion between the plurality of row conductors and the plurality of column conductors, and a bottom portion between the plurality of column conductors and the inside surface. In an embodiment, the deformable digital skin is mechanically deformable in at least one of the top portion, the middle portion and the bottom portion. In an embodiment, the bottom portion is locally mechanically deformable and a conductive layer is positioned on the side of the bottom portion away from the rest of the digital skin such that when the bottom portion is locally mechanically deformed, at least some portions of some of the conductors are moved closer to the conductive layer. In an embodiment, a deformable digital skin is used as part of a grip for an object with a grip such as a golf club, a tennis racquet, a steering wheel, a lever, a game controller, or any other object with a grip.

In an embodiment, the row and column conductors are designed so that the amount of signal coupled between them varies with the various touch events, from the farthest hover, through contact, and all the way to maximum pressure or grip. In an embodiment, the variation in signal from the farthest hover to maximum pressure or grip comprises a range of detectable touch states, which may comprise at least three touch states (i.e., hover, contact and pressure) in addition to an untouched state. In an embodiment, the variation in signal representing the hover touch state comprises a plurality of discrete levels. In an embodiment, the variation in signal representing the contact touch state comprises a plurality of discrete levels. In an embodiment, the variation in signal from the farthest hover to maximum pressure or grip comprises a range of detectable touch states. As discussed above, because the touch sensor ultimately detects touch due to a change in coupling, it is not of specific importance, except for reasons that may otherwise be apparent to a particular embodiment, whether the touch-related coupling causes an increase in the amount of signal present on the column or a decrease in the amount of signal present on the column.

To identify touch, signal receivers receive signals present on the column conductors and signal processors analyzes the received signals to determine an amount of the transmitted signal that is coupled to each column. In an embodiment, the identification can be supported with a frequency analysis technique (e.g., Fourier transform), or by using a filter bank. In an embodiment, the receiver receives a frame of signals, which frame is processed through an FFT, and thus, a measure is determined for at least the transmitted frequency. In an embodiment, the FFT provides an in-phase and quadrature measure for at least the transmit frequency, for each frame.

In an embodiment, signal emitters are conductively coupled to row conductors. The signal emitters each emit respective source signals onto the row conductors associated therewith. The source signals differ in frequency, e.g., each being a sine wave or a combination of sine waves that differs from the others. The source signals may also differ in other ways, such as, in code (as in CDM). In an embodiment, transmission of more complex source signals (e.g., having a combination of sine waves, instead of a single sine wave) may increase sensitivity. In an embodiment, transmission of more complex source signals may increase sensitivity further if high and low frequency signals are combined. In an embodiment, the source signals transmitted on separate row conductors are frequency-orthogonal. In an embodiment, the receiver is coupled to the column conductor and adapted to capture a frame of signals present on the coupled column conductor. In such embodiment, the signal receiver receives signals present on the column conductor and a signal processor analyzes the received signals to determine an amount corresponding to each of the orthogonal transmitted signal coupled between them. Touch is indicated where the amount of signal coupled between them changes.

In an embodiment, from the received signal, the signal receiver/signal processor can determine a value (and in an embodiment an in-phase and quadrature value) for each frequency, from a list of frequencies, found in the signal received on that column conductor. In an embodiment, where the value corresponding to a frequency is greater or lower than a threshold, or changes from a prior value (or changes from a prior value by an amount greater than a threshold), that information may be used to identify a touch event on the touch sensitive device. In an embodiment, the value information, which may correspond to various physical phenomena including the distance of the touch from the touch-sensitive object, the size of the touch-sensitive object, the pressure with which the user is pressing or gripping the touch-sensitive object, any fraction of the touch-sensitive object that is being touched, etc., may be used to identify the touch state from the range of detectable touch states. In an embodiment, changes in the value information may be used to identify the touch state from the range of detectable touch states. In an embodiment, the determined values are not self-determinative of touch state, but rather are further processed along with other values to determine touch states.

In an embodiment, a signal processor is adapted to determine a measurement from each frame corresponding to an amount of the source signals present on the column conductor. In an embodiment, the signal processor is further adapted to determine a touch state from the range of touch states, based at least in part on the corresponding measurement. In an embodiment, the signal processor generates a heat map from at least one of the measurement, the heat map corresponding to electromagnetic disturbance taking place proximate to the digital skin and/or embedded touch sensor.

In an embodiment, the range of touch states include none, hover, contact, and pressure or grip. In an embodiment, “none” means there is no detection of a change in proximity to the row/column crossing, e.g., a stylus or user's fingers, hand, or forearm are not in the vicinity of the touch-sensitive object. As used here, generally, “hover” refers to a touch state corresponding to detectable location of a capacitive object (e.g., stylus, user's fingers, hands, or forearm) from the limit of detection of the touch-sensitive object through but not including include actual contact with the touch-sensitive object. As used here, generally, “contact” refers to a touch state corresponding to a detectable contact between the touch-sensitive object and the capacitive object, all the way through being to maximum pressure or grip. As will be apparent to a person of skill in the art in view of this disclosure, the number of touch states and association between those states and any substates are design choices and should be selected to provide the desired granularity for the touch sensitive device. Moreover, it is not necessary for substates to have equal granularity with other substates. For example, in an embodiment, more granularity is provided on the contact states or on the division between the hover state and the contact state. In an embodiment, additional granularity is provided on hover states. In an embodiment, additional granularity is provided on pressure/grip states. In an embodiment, locally mechanically deformable layers are used to increase measurable granularity.

In an embodiment, the touch-sensitive object can provide granular, multi-level information relative to the proximity of a capacitive object such as a stylus, user's fingers or hands with respect to a touch-sensitive object. For example, in an embodiment, as grip changes on a touch-sensitive tennis racquet grip, the touch-sensitive object detects a change in the surface area of the fingers and hands on the surface of the grip of the object. In an embodiment, as grip changes on a touch-sensitive tennis racquet grip, the surface of the grip is moved in proximity to the conductors, and thus, the proximity of the capacitive object to the conductors result detected changes. In an embodiment, both the change in the surface area and the proximity of the capacitive object to the conductors result detected changes.

In an embodiment, the range of touch states provided by the touch-sensitive object can be used to model a capacitive object and its position and orientation with respect to the touch-sensitive object. In an embodiment, such modeling can be used to provide visual feedback, including a visual 3-D model of the capacitive object, in a VR/AR setting. For example, an overlay of 2-D and 3-D “holographic” visual feedback in VR/AR settings can be based on the real-world positions of the user's fingers, hands, wrists and forearms on or in proximity to a physical object containing one or more detectors. Further, where the touch-sensitive objects make granular measurements of the location of capacitive objects relative to a touch-sensitive object, the measurements can be used to recreate the location and orientation of fingers, hands and possibly other parts including wrists and/or forearms because of the limited number of ways in which a hand and forearm can move relative to the fingers—e.g., finite ranges and degrees of freedom.

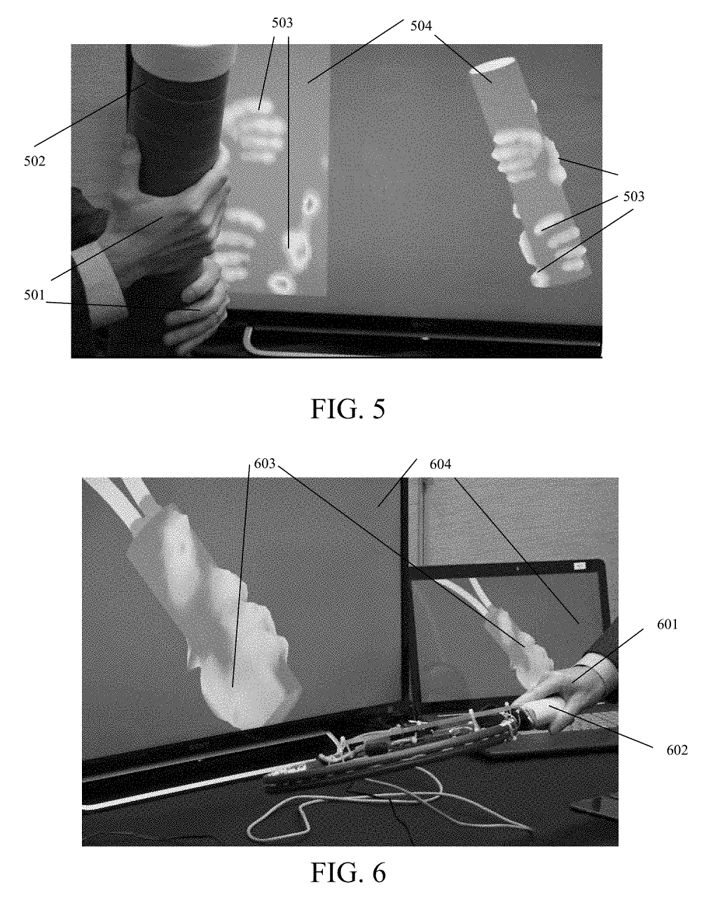

Turning now to FIG. 5, an illustrative example of computer-generated touch state information of a touch-sensitive object according to the present disclosure is shown. Specifically, FIG. 5 shows an exemplary touch-sensitive object 502 according to the disclosure, with a user's hands 501 positioned in proximity thereto and an illustration of that touch-sensitive object 504 with a computer-generated heat map 503 superimposed thereon. A computer generated heat map 503 illustrates sensed contacts between the user's hands and the touch-sensitive object. The heights and colors shown are merely illustrative. As illustrated in FIG. 5, an embodiment of the touch-sensitive object 502 disclosed herein may be used to provide information concerning the touch state of the user's hands in relation to the touch-sensitive object, which, as illustrated, can provide a visual display 504 of hover, touch, grip and pressure.

Turning now to FIG. 6, an illustrative example of computer-generated touch state information of an exemplary tennis racket according to the present disclosure is shown. FIG. 6 shows an exemplary tennis racket 602 according to the disclosure, with a user's hand 601 positioned in proximity thereto and an illustration of the tennis racket 602 with a computer-generated heat map 603 superimposed thereon. A computer generated heat map 603 illustrates sensed contact between the user's hand and the tennis racket grip. The heights and colors shown are merely illustrative. As illustrated in FIG. 6, an embodiment of the tennis racket 602 disclosed herein may be used to provide information concerning the touch state of the user's hand in relation to the tennis racket, which, as illustrated, can provide a visual display 604 of hover, touch, grip and pressure.

In an embodiment, a reconstruction of the hover, contact and pressure information may be configured to display as a 3-D model, allowing a user to see his or her fingers, and potentially hands, wrists and/or forearms relative to the touch-sensitive object in a VR/AR view. In an embodiment, the range of touch states corresponding to hover may extend at least 5 mm from the surface of the touch-sensitive object. In an embodiment, the range of touch states corresponding to hover may extend up to 10 mm from the surface of the touch-sensitive object. In an embodiment, a range of touch states corresponding to hover may extend more than 10 mm from the surface of the touch-sensitive object.

In an embodiment, on-the-fly tuning may be done to permit extended hover while maintaining a contact-sensitive and touch-sensitive object. On-the-fly tuning may be implemented by employing different signals in a non-hover state versus a hover state. On-the-fly tuning may be implemented by employing different signals in a far-hover state versus a near-hover state. On-the-fly tuning may be implemented by employing differing properties of the sensor when the capacitive object is less proximate versus when the capacitive object is more proximate (e.g., far-hover versus near hover, or hover versus contact.) In an embodiment, such differing properties of the sensor may involve changing frequency. In an embodiment, higher frequencies are used when detecting capacitive objects nearer to the sensor, while lower frequencies are employed when detecting capacitive objects farther from the sensor. In an embodiment, differing properties of the sensor may involve changing impedance of the receiver or transmitter. In an embodiment, the receiver's impedance is increased when detecting capacitive objects nearer to the sensor. In an embodiment, the transmitter impedance is increased when detecting capacitive objects farther from the sensor. In an embodiment, some of the transmitters (e.g., every other one) may be taken to very high impedance, effectively turning them off, when detecting capacitive objects farther from the sensor. In an embodiment, differing properties of the sensor may involve swapping the receivers and transmitters. In an embodiment, the transmitter's conductors are closer to the touch surface when detecting capacitive objects farther from the sensor. In an embodiment, the receiver's conductors are closer to the touch surface when detecting capacitive objects nearer to the sensor. In an embodiment, differing properties of the sensor may involve changing the driving voltage. In an embodiment, the driving voltage may operate with lower voltage when detecting capacitive objects closer to the sensor, and with higher voltage when detecting capacitive objects farther from the sensor. It will be apparent to a person of skill in the art, in view of this disclosure, that on-the-fly tuning may be implemented to improve the granularity and range of touch that can be reported.

U.S. patent application Ser. No. 15/162,240, filed May 23, 2016, entitled “Transmitting and Receiving System and Method for Bidirectional Orthogonal Signaling Sensors,” the entire disclosure of which is incorporated herein by reference, provides user, hand and object discrimination in a fast multi-touch sensor. In an embodiment, bidirectional orthogonal signaling is used in connection with touch-sensitive objects to provide the benefits as explained in that application. Where bidirectional orthogonal signaling is used, each of the rows and columns may be used to both receive and transmit signals.

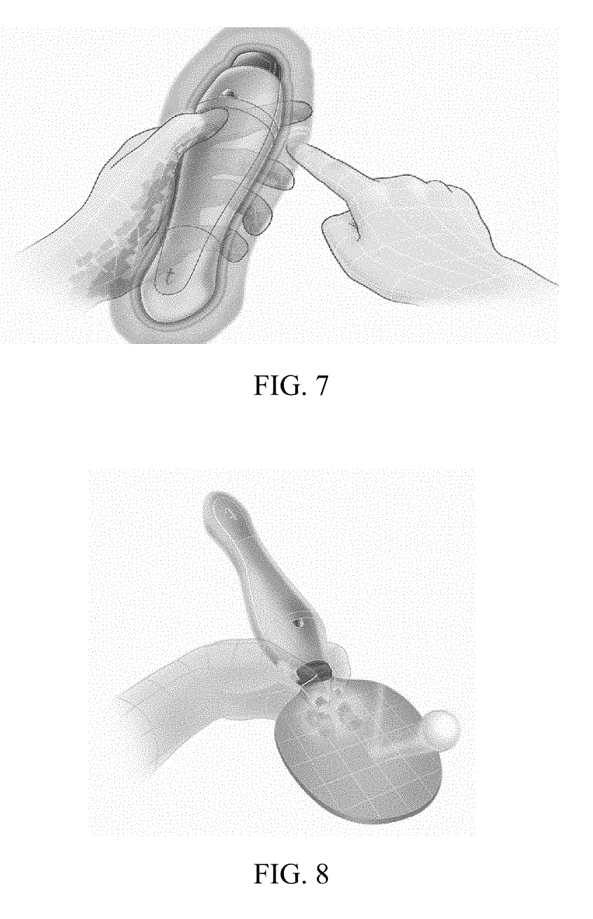

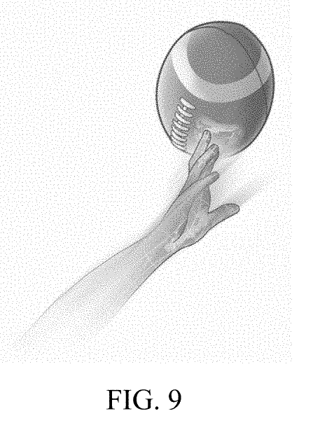

FIGS. 7-9 respectively show a composite illustration showing heat maps of the interaction that are detected by the touch-sensitive objects, and wireframes showing computed locations of fingers, hands, and wrists based on sensed information. As used herein, the term featureless touch-sensitive object refers to touch-sensitive objects that have surfaces without specific physical buttons, sliders, and other visual input controls. The term feature-sparse touch-sensitive object include touch-sensitive objects having some physical features, which may be presented by haptic feedback, for buttons, sliders, and other input controls or other features of a touch-sensitive object, but which physical features are intended to be enhanced in an VR/AR experience. Haptics may include, without limitation, moving mechanical parts, robotic graphics, electrostatic feedback and/or electroshock feedback. In an embodiment, in an VR/AR setting, feature-sparse and/or haptic touch-sensitive object can be seen as having rich features. Thus, for example, while a feature-sparse haptic touch-sensitive object may tactually seem to have buttons, sliders, other visual input controls can be provided to featureless and/or feature-sparse touch-sensitive objects in VR/AR settings. Moreover, dynamic physical feedback may be presented while using the touch-sensitive object in this setting. Thus, even though the user sees limited features or no features at all in a real-world setting, buttons, sliders, other visual input controls, outlines and labels can be added in the VR/AR setting.

A significant limitation of using featureless or feature-sparse touch-sensitive objects in VR/AR is the inability to “see” a user's inputs in the VR/AR view. In an embodiment, using the teachings herein, granular low-latency touch information can be used to compute reconstructed styli, fingers, and potentially hands and/or wrists and/or forearms in VR/AR settings, with low latency. In an embodiment, such reconstructed capacitive objects can be rendered in 3-D, e.g., with shadowing or without. The reconstructed capacitive objects can be combined in low latency VR/AR systems, thus, providing the user with a touch-sensitive objects has VR/AR view controls—and allows the user to see the user's own interaction in the VR/AR view. For example, in an embodiment, in addition to seeing the VR/AR controls in the VR/AR view, the user can also see a model of the user's own interaction.

Moreover, the reconstructed capacitive objects can be combined in low latency VR/AR systems that provide 3-D haptics, thus, providing the user with physical buttons and controllers on a real-world touch-sensitive objects that mirrors software defined buttons and controls of a VR/AR touch-sensitive object—and allows the user to see the user's own interaction in the VR/AR view. For example, in an embodiment, 3-D haptics may create physical input surfaces that can flexibly deform their physical controls to match the VR/AR digital controls of a given VR/AR application, thus, for example, in addition to both seeing the VR/AR controls in the VR/AR view, and feeling the haptic controls, the user can also see a model of the user's own interaction.

The touch state information provided by the touch-sensitive objects presented herein allows application and operating system software to have information from which hover, contact, grip, pressure and gesture on a touch-sensitive object can be identified. In an embodiment, the touch state information is used to determine particular positions or combinations of positions where a tool-tip or other feedback is desirable, and such tool-tip or other feedback may be presented in the VR/AR representation. In an embodiment, the VR/AR view shows a supplemental display, such as a balloon, when, for example, a user hovers over or contacts a particular portion of touch-sensitive object, or hovers over or contacts a touch-sensitive object in a particular way. In an embodiment, the supplemental display contains, for example, help information, or use statistics, or ball pressure, or other information.

The present systems are described above with reference to are described above with reference to block diagrams and operational illustrations of objects sensitive to hover, contact and pressure in frequency division modulated touch systems. It is understood that each block of the block diagrams or operational illustrations, and combinations of blocks in the block diagrams or operational illustrations, may be implemented by means of analog or digital hardware and computer program instructions. Computer program instructions may be provided to a processor of a general purpose computer, special purpose computer, ASIC, or other programmable data processing apparatus, such that the instructions, which execute via a processor of a computer or other programmable data processing apparatus, implements the functions/acts specified in the block diagrams or operational block or blocks. Except as expressly limited by the discussion above, in some alternate implementations, the functions/acts noted in the blocks may occur out of the order noted in the operational illustrations. For example, and generally in block diagram figures, the order of execution if blocks shown in succession may in fact be executed concurrently or substantially concurrently or, where practical, any blocks may be executed in a different order with respect to the others, depending upon the functionality/acts involved.

While the invention has been particularly shown and described with reference to a preferred embodiment thereof, it will be understood by those skilled in the art that various changes in form and details may be made therein without departing from the spirit and scope of the invention.

What is claimed is:

1. A touch-sensitive object, comprising:
an object having a digital skin covering at least a portion thereof, the digital skin having a plurality of row conductors embedded therein,
a plurality of column conductors positioned in proximity to the row conductors, such that the path of each row conductors of the plurality of row conductors crosses the path of each of the column conductors of the plurality of column conductors;
plurality of signal emitters, each of the plurality of signal emitters operatively connected to separate ones of the plurality of embedded row conductors, each of the plurality of signal emitters adapted to simultaneously emit one of a set of source signals;
plurality of signal receivers, each of the plurality of signal receivers operatively connected to separate ones of the plurality of embedded column conductors, each of the plurality of signal receivers being adapted to receive a frame corresponding to signals present on the column conductor to which it is operatively connected while the frame is acquired, each of the signal receivers being adapted to receive its frames simultaneously with each other signal receiver;
signal processor adapted to generate a heat map reflecting electromagnetic disturbance proximate to the digital skin based, at least in part, on the received frames.

2. The touch-sensitive object of claim 1, wherein the digital skin is deformable in response to touch.

3. The touch-sensitive object of claim 2, wherein the plurality of columns are embedded in the digital skin.

4. The touch-sensitive object of claim 3, wherein the digital skin, the plurality of signal emitters and the plurality of signal receivers form a first touch sensor, the object further comprising a second touch sensor.

5. The touch-sensitive object of claim 4, wherein the signal processor is further adapted to generate another output reflecting electromagnetic disturbance proximate to the second touch sensor.

6. The touch-sensitive object of claim 5, wherein the another output is a heat map.

7. The touch-sensitive object of claim 5, wherein the second touch sensor is formed from key base, at least one transmit antennae and at least one receive antennae proximate to the key base, a signal emitter associated with each of the at least one transmit antennae, and at least one signal receiver operatively coupled with at least one of the at least one receive antenna.

8. The touch-sensitive object of claim 6, wherein the another output is adapted to reflect one of a range of touch states, including a range of hover states, a range of contact states and at least one fully depressed state.

9. The touch-sensitive object of claim 2, wherein the deformable digital skin comprises:
an inside surface proximate to the object,
an outside surface distal from the object,
a top portion between the plurality of row conductors and the outside surface, and
a bottom portion between the plurality of row conductors and the inside surface;
and wherein the deformable digital skin is mechanically deformable in the top portion.

10. The touch-sensitive object of claim 2, wherein the deformable digital skin comprises:
an inside surface proximate to the object,
an outside surface distal from the object,
a top portion between the plurality of row conductors and the outside surface, and
a bottom portion between the plurality of row conductors and the inside surface;
and wherein the deformable digital skin is mechanically deformable in the bottom portion.

11. The touch-sensitive object of claim 10, wherein the deformable digital skin is also mechanically deformable in the top portion.

12. The touch-sensitive object of claim 9, wherein at least part of an outer portion of the object comprises mechanically deformable material having an outer surface, and the outer surface of the mechanically deformable material spans at least a part of the same portion of the surface of the object as the digital skin.

13. The touch-sensitive object of claim 12, wherein the mechanically deformable material is dielectric.

14. The touch-sensitive object of claim 3, wherein the deformable digital skin comprises:
an inside surface proximate to the object,
an outside surface distal from the object,
a top portion between the plurality of row conductors and the outside surface,
a middle portion between the plurality of row conductors and the plurality of column conductors, and
a bottom portion between the plurality of column conductors and the inside surface; and
wherein the deformable digital skin is deformable in the top portion.

15. The touch-sensitive object of claim 14, wherein at least part of an outer portion of the object comprises mechanically deformable material having an outer surface, and the outer surface of the mechanically deformable material spans at least the a part of the same portion of the surface of the object as the digital skin.

16. The touch-sensitive object of claim 15, wherein the mechanically deformable material is dielectric.

17. The touch-sensitive object of claim 15, further comprising:
conductive material spanning at least a portion of the object, the conductive material positioned beneath the outer surface of the mechanically deformable material.

18. The touch-sensitive object of claim 3, wherein the deformable digital skin comprises:
an inside surface proximate to the object,
an outside surface distal from the object,
a top portion between the plurality of row conductors and the outside surface,
a middle portion between the plurality of row conductors and the plurality of column conductors, and
a bottom portion between the plurality of column conductors and the inside surface; and
wherein the deformable digital skin is deformable in the middle portion.

19. The touch-sensitive object of claim 18, wherein at least a portion of the object comprises mechanically deformable outer portion, and the mechanically deformable outer portion spans at least a part of the same portion of the surface of the object as the digital skin.

20. The touch-sensitive object of claim 19, wherein the mechanically deformable outer portion is dielectric.

21. The touch-sensitive object of claim 19, further comprising:
conductive material spanning at least a portion of the object, the conductive material positioned beneath the outer surface of the mechanically deformable outer portion.

22. The touch-sensitive object of claim 3, wherein the deformable digital skin comprises:
an inside surface proximate to the object,
an outside surface distal from the object,
a top portion between the plurality of row conductors and the outside surface,
a middle portion between the plurality of row conductors and the plurality of column conductors, and
a bottom portion between the plurality of column conductors and the inside surface; and
wherein the deformable digital skin is deformable in the bottom portion.

23. The touch-sensitive object of claim 22, the object further comprising:
conductive material spanning at least a portion of the object, the conductive material positioned beneath the inside surface.

24. The touch-sensitive object of claim 1, wherein the plurality of row conductors are arranged such that they are oriented in a clockwise helix and the plurality of column conductors are oriented in a counterclockwise helix with respect thereto.

25. The touch-sensitive object of claim 1, wherein the plurality of row conductors are arranged such that they are oriented in a counterclockwise helix and the plurality of column conductors are arranged such that they are oriented in a clockwise helix with respect thereto.

26. The touch-sensitive object of claim 1, wherein the plurality of row conductors and the plurality of column conductors are oriented in a helical wind.

27. The touch-sensitive object of claim 1, wherein the plurality of row conductors are arranged such that they are oriented in a clockwise helix and the plurality of column conductors are arranged such that they are longitudinally oriented with respect thereto.

28. The touch-sensitive object of claim 1, wherein the plurality of row conductors are arranged such that they are oriented in a counterclockwise helix and the plurality of column conductors are arranged such that they are longitudinally oriented with respect thereto.

29. The touch-sensitive object of claim 1, wherein the plurality of row conductors are arranged such that they are oriented in concentric circles and the plurality of column conductors are arranged such that they are longitudinally oriented with respect thereto.

30. A touch-sensitive object, comprising:
an object covered by a protective surface;
digital skin underneath at least a portion of the protective surface, the digital skin having a plurality of row conductors embedded therein,
a plurality of column conductors positioned in proximity to the row conductors, such that the path of each row conductors of the plurality of row conductors crosses the path of each of the column conductors of the plurality of column conductors;
plurality of signal emitters, each of the plurality of signal emitters operatively connected to separate ones of the plurality of embedded row conductors, each of the plurality of signal emitters adapted to simultaneously emit one of a set of source signals;
plurality of signal receivers, each of the plurality of signal receivers operatively connected to separate ones of the plurality of embedded column conductors, each of the plurality of signal receivers being adapted to receive a frame corresponding to signals present on the column conductor to which it is operatively connected while the frame is acquired, each of the signal receivers being adapted to receive its frames simultaneously with each other signal receiver;
signal processor adapted to generate a heat map reflecting electromagnetic disturbance proximate to the protective surface based, at least in part, on the received frames.

31. The touch-sensitive object of claim 30, wherein the protective surface is deformable in response to touch.

32. The touch-sensitive object of claim 31, wherein the plurality of columns are embedded in the digital skin.

33. The touch-sensitive object of claim 32, wherein the protective surface, the digital skin, the plurality of signal emitters and the plurality of signal receivers form a first touch sensor, the object further comprising:
second touch sensor.

34. The touch-sensitive object of claim 33, wherein the signal processor is further adapted to generate another output reflecting electromagnetic disturbance proximate to the second touch sensor.

35. The touch-sensitive object of claim 34, wherein the another output is a heat map.

36. The touch-sensitive object of claim 34, wherein the second touch sensor is formed from key base, at least one transmit antennae and at least one receive antennae proximate to the key base, a signal emitter associated with each of the at least one transmit antennae, and at least one signal receiver operatively coupled with at least one of the at least one receive antennae.

37. The touch-sensitive object of claim 35, wherein the another output is adapted to reflect one of a range of touch states, including a range of hover states, a range of contact states and at least one fully depressed state.

38. The touch-sensitive object of claim 31,
wherein the deformable digital skin has
an inside surface distal from the protective surface,
an outside surface proximate to the protective surface,
a top portion between the plurality of row conductors and the protective surface, and
a bottom portion between the plurality of row conductors and the inside surface, and
wherein the deformable digital skin is mechanically deformable in the top portion.

39. The touch-sensitive object of claim 31,
wherein the deformable digital skin has
an inside surface distal from the protective surface,
an outside surface proximate to the protective surface,
a top portion between the plurality of row conductors and the protective surface, and
a bottom portion between the plurality of row conductors and the inside surface, and
wherein the deformable digital skin is mechanically deformable in the bottom portion.

40. The touch-sensitive object of claim 39, wherein the deformable digital skin is also mechanically deformable in the top portion.

41. The touch-sensitive object of claim 38, wherein at least part of the protective surface on the object comprises mechanically deformable material having an outer surface, and the outer surface of the mechanically deformable material spans at least a part of the same portion of the surface of the object as the digital skin.

42. The touch-sensitive object of claim 41, wherein the mechanically deformable material is dielectric.

43. The touch-sensitive object of claim 32,
wherein the deformable digital skin has
an inside surface distal from the protective surface,
an outside surface proximate to the protective surface,
a top portion between the plurality of row conductors and the protective surface,
a middle portion between the plurality of row conductors and the plurality of column conductors, and
a bottom portion between the plurality of column conductors and the inside surface, and
wherein the deformable digital skin is deformable in the top portion.

44. The touch-sensitive object of claim 43, wherein at least part of the protective surface comprises mechanically deformable material having an outer surface, and the outer surface of the mechanically deformable material spans at least a part of the same portion of the surface of the object as the digital skin.

45. The touch-sensitive object of claim 44, wherein the mechanically deformable material is dielectric.

46. The touch-sensitive object of claim 44, further comprising:
conductive material spanning at least a portion of the object, the conductive material positioned beneath the surface of the mechanically deformable material.

47. The touch-sensitive object of claim 32,
wherein the deformable digital skin has
an inside surface distal from the protective surface,
an outside surface proximate to the protective surface,
a top portion between the plurality of row conductors and the protective surface,
a middle portion between the plurality of row conductors and the plurality of column conductors, and
a bottom portion between the plurality of column conductors and the inside surface, and
wherein the deformable digital skin is deformable in the middle portion.

48. The touch-sensitive object of claim 47, wherein at least a portion of the protective surface comprises mechanically deformable outer portion, and the mechanically deformable outer portion spans at least a part of the same portion of the surface of the object as the digital skin.

49. The touch-sensitive object of claim 48, wherein the mechanically deformable outer portion is dielectric.

50. The touch-sensitive object of claim 48, further comprising:
conductive material spanning at least a portion of the protective surface, the conductive material positioned beneath the surface of the mechanically deformable outer portion.

51. The touch-sensitive object of claim 32,
wherein the deformable digital skin has
an inside surface distal from the protective surface,
an outside surface proximate to the protective surface,
a top portion between the plurality of row conductors and the protective surface,
a middle portion between the plurality of row conductors and the plurality of column conductors, and
a bottom portion between the plurality of column conductors and the inside surface, and
wherein the deformable digital skin is deformable in the bottom portion.

52. The touch-sensitive object of claim 51, the object further comprising:
conductive material spanning at least a portion of the protective surface, the conductive material positioned beneath the inside surface.

53. The touch-sensitive object of claim 30, wherein the plurality of row conductors are arranged such that they are oriented in a clockwise helix and the plurality of column conductors are oriented in a counterclockwise helix with respect thereto.

54. The touch-sensitive object of claim 30, wherein the plurality of row conductors are arranged such that they are oriented in a counterclockwise helix and the plurality of column conductors are arranged such that they are oriented in a clockwise helix with respect thereto.

55. The touch-sensitive object of claim 30, wherein the plurality of row conductors and the plurality of column conductors are oriented in a helical wind.

56. The touch-sensitive object of claim 30, wherein the plurality of row conductors are arranged such that they are oriented in a clockwise helix and the plurality of column conductors are arranged such that they are longitudinally oriented with respect thereto.

57. The touch-sensitive object of claim 30, wherein the plurality of row conductors are arranged such that they are oriented in a counterclockwise helix and the plurality of column conductors are arranged such that they are longitudinally oriented with respect thereto.

58. The touch-sensitive object of claim 30, wherein the plurality of row conductors are arranged such that they are oriented in concentric circles and the plurality of column conductors are arranged such that they are longitudinally oriented with respect thereto.

59. A touch-sensitive object, comprising:
an object having a grip covering at least a portion thereof, the grip having a plurality of row conductors embedded therein;
a plurality of column conductors positioned in proximity to the row conductors, such that the path of each row conductors of the plurality of row conductors crosses the path of each of the column conductors of the plurality of column conductors;
plurality of signal emitters, each of the plurality of signal emitters operatively connected to separate ones of the plurality of embedded row conductors, the plurality of signal emitters adapted to simultaneously emit one of a set of source signals;
plurality of signal receivers, each of the plurality of signal receivers operatively connected to separate ones of the plurality of embedded column conductors, each of the plurality of signal receivers being adapted to receive a frame corresponding to signals present on the column conductor to which it is operatively connected while the frame is acquired, each of the signal receivers being adapted to receive its frames simultaneously with each other signal receiver;
signal processor adapted to generate a heat map reflecting electromagnetic disturbance proximate to the grip based, at least in part, on the received frames.

60. The touch-sensitive object of claim 59, wherein the grip is deformable in response to touch.

61. The touch-sensitive object of claim 60, wherein the plurality of columns are embedded in the digital skin.

62. The touch-sensitive object of claim 61, wherein the grip, the plurality of signal emitters and the plurality of signal receivers form a first touch sensor, the object further comprising:
second touch sensor.

63. The touch-sensitive object of claim 62, wherein the signal processor is further adapted to generate another output reflecting electromagnetic disturbance proximate to the second touch sensor.

64. The touch-sensitive object of claim 63, wherein the another output is a heat map.

65. The touch-sensitive object of claim 63, wherein the second touch sensor is formed from key base, at least one transmit antennae and at least one receive antennae proximate to the key base, a signal emitter associated with each of the at least one transmit antennae, and at least one signal receiver operatively coupled with at least one of the at least one receive antennae.

66. The touch-sensitive object of claim 64, wherein the another output is adapted to reflect one of a range of touch states, including a range of hover states, a range of contact states and at least one fully depressed state.

67. The touch-sensitive object of claim 60,
wherein the deformable grip has
an inside surface proximate to the object,
an outside surface distal from the object,
a top portion between the plurality of row conductors and the outside surface, and
a bottom portion between the plurality of row conductors and the inside surface, and
wherein the deformable grip is mechanically deformable in the top portion.

68. The touch-sensitive object of claim 60,
wherein the deformable grip has
an inside surface proximate to the object,
an outside surface distal from the object,
a top portion between the plurality of row conductors and the outside surface, and
a bottom portion between the plurality of row conductors and the inside surface, and
wherein the deformable grip is mechanically deformable in the bottom portion.

69. The touch-sensitive object of claim 68, wherein the deformable grip is also mechanically deformable in the top portion.

70. The touch-sensitive object of claim 67, wherein at least part of the grip on the object comprises mechanically deformable material having an outer surface, and the outer surface of the mechanically deformable material spans at least a part of the same portion of the surface of the object as the grip.

71. The touch-sensitive object of claim 70, wherein the mechanically deformable material is dielectric.

72. The touch-sensitive object of claim 61,
wherein the deformable grip has
an inside surface proximate to the object,
an outside surface distal from the object,
a top portion between the plurality of row conductors and the outside surface,
a middle portion between the plurality of row conductors and the plurality of column conductors, and
a bottom portion between the plurality of column conductors and the inside surface, and
wherein the deformable grip is deformable in the top portion.

73. The touch-sensitive object of claim 72, wherein at least part of an outer portion of the object comprises mechanically deformable material having an outer surface, and the outer surface of the mechanically deformable material spans at least a part of the same portion of the surface of the object as the grip.

74. The touch-sensitive object of claim 73, wherein the mechanically deformable material is dielectric.

75. The touch-sensitive object of claim 73, further comprising:
conductive material spanning at least a portion of the object, the conductive material positioned beneath the surface of the mechanically deformable material.

76. The touch-sensitive object of claim 61,
wherein the deformable grip has
an inside surface proximate to the object,
an outside surface distal from the object,
a top portion between the plurality of row conductors and the outside surface,
a middle portion between the plurality of row conductors and the plurality of column conductors, and
a bottom portion between the plurality of column conductors and the inside surface, and
wherein the deformable grip is deformable in the middle portion.

77. The touch-sensitive object of claim 76, wherein at least a portion of the object comprises mechanically deformable outer portion, and the mechanically deformable outer portion spans at least a part of the same portion of the surface of the object as the grip.

78. The touch-sensitive object of claim 77, wherein the mechanically deformable outer portion is dielectric.

79. The touch-sensitive object of claim 77, further comprising:
conductive material spanning at least a portion of the object, the conductive material positioned beneath the outer surface of the mechanically deformable outer portion.

80. The touch-sensitive object of claim 61,
wherein the deformable grip has
an inside surface proximate to the object,
an outside surface distal from the object,
a top portion between the plurality of row conductors and the outside surface,
a middle portion between the plurality of row conductors and the plurality of column conductors, and
a bottom portion between the plurality of column conductors and the inside surface, and
wherein the deformable grip is deformable in the bottom portion.

81. The touch-sensitive object of claim 80, the object further comprising:
conductive material spanning at least a portion of the object, the conductive material positioned beneath the inside surface.

82. The touch-sensitive object of claim 59, wherein the plurality of row conductors are arranged such that they are oriented in a clockwise helix and the plurality of column conductors are oriented in a counterclockwise helix with respect thereto.

83. The touch-sensitive object of claim 59, wherein the plurality of row conductors are arranged such that they are oriented in a counterclockwise helix and the plurality of column conductors are arranged such that they are oriented in a clockwise helix with respect thereto.

84. The touch-sensitive object of claim 59, wherein the plurality of row conductors and the plurality of column conductors are oriented in a helical wind.

85. The touch-sensitive object of claim 59, wherein the plurality of row conductors are arranged such that they are oriented in a clockwise helix and the plurality of column conductors are arranged such that they are longitudinally oriented with respect thereto.

86. The touch-sensitive object of claim 59, wherein the plurality of row conductors are arranged such that they are oriented in a counterclockwise helix and the plurality of column conductors are arranged such that they are longitudinally oriented with respect thereto.

87. The touch-sensitive object of claim 59, wherein the plurality of row conductors are arranged such that they are oriented in concentric circles and the plurality of column conductors are arranged such that they are longitudinally oriented with respect thereto.
